(19) United States
(12) Patent Application Publication
(10) Pub. No.: US 2023/0095058 A1
(43) Pub. Date: Mar. 30, 2023

(54) METHODS AND SYSTEMS FOR SELECTING PARAMETERS TO APPROXIMATE DESIRED PROPERTIES OF STRUCTURAL COLOR

(71) Applicants: BASF SE, Ludwigshafen (DE); PRESIDENT AND FELLOWS OF HARVARD COLLEGE, Cambridge, MA (US)

(72) Inventors: Keith Task, Beachwood, OH (US); Rupa Hiremath Darji, Tarrytown, NY (US); Vinothan Manoharan, Cambridge, MA (US); Anna B. Stephenson, Cambridge, MA (US); Victoria Hwang, Cambridge, MA (US); Ming Xiao, Cambridge, MA (US)

(21) Appl. No.: 17/908,600

(22) PCT Filed: Mar. 2, 2021
(86) PCT No.: PCT/US21/70213

§ 371 Date: Sep. 1, 2022

Related U.S. Application Data
(60) Provisional application No. 63/050,946, filed on Jul. 13, 2020.
(60) Provisional application No. 62/984,582, filed on Mar. 3, 2020.

(51) Int. Cl. G06F 30/25; C09D 5/02; G01N 21/41

(52) U.S. Cl. CPC G06F 30/25; C09D 5/024; G01N 21/41; G06F 2111/08

(57) ABSTRACT

Exemplary embodiments relate to techniques for determining structural color from parameters of an array of nanopartides. The techniques include inputting structural and optical parameters and performing a probabilistic simulation to determine the structural color. An evolutionary optimization may be performed to determine parameters of the array of nanoparticles according to desired properties of structural color. The evolutionary optimization may employ the probabilistic simulation and further adjust one or more parameters of the array to approximate the desired properties of the structural color. Based on applying the probabilistic simulation, the technique may generate an output describing a value, or a range of values, for the one or more parameters of the array of nanoparticles that are selected to approximate the desired properties of the structural color.

### CROSS-REFERENCE TO RELATED APPLICATIONS

The present application claims priority to U.S. Provisional Patent Application No. 62/984,582, filed Mar. 3, 2020, entitled “Methods and Systems for Selecting Parameters to Approximate Desired Properties of Structural Color,” the disclosure of which is incorporated herein by reference in its entirety, and to U.S. Provisional Application No. 63/050,946, filed on Jul. 13, 2020, entitled “Methods and Systems for Selecting Parameters to Approximate Desired Properties of Structural Color,” the disclosure of which is incorporated herein by reference in its entirety.

### BACKGROUND

Structural color relies on the physical properties of a material to produce color. These physical properties give rise to interference among scattered light waves, which gives the scattered light a particular color. This makes structural color different from other types of color that rely on the chemical properties of the material.

Although structural color is common in nature, it has been difficult to reproduce by conventional techniques. Among other reasons, there is an extremely large number of configurations of physical properties that can affect the way that light scatters from a surface. Moreover, when the light scatters from the surface, the interference effects can be hard to predict because of the complex ways that the light interacts with the material and with itself. These problems make it difficult to identify a specific set (or sets) of properties that will give rise to a specific desired structural color.

### SUMMARY

There is need for the ability to reliably predict the structural color of particles and materials. Further, there is a need for the ability to design particles and physical properties of materials according to desired optical properties. The exemplary embodiments provide methods, mediums, and systems for selecting and designing parameters of a nanoparticle or nanoparticle array that result in desired optical properties for structural color of the nanoparticle array.

According to one aspect, there is a method for determining an optical output parameter indicative of structural color. The method may include: providing, to a processor of a simulation system, one or more input properties, wherein each of the one or more input properties is indicative of a property of an array of nanoparticles; providing, to the processor, one or more input parameters for an optical simulation; performing, by the processor, the optical simulation by applying a stochastic model of the array of nanoparticles according to the input parameters; and determining, by the processor, and from the optical simulation, an output optical parameter indicative of structural color.

In another aspect, there is a simulation system for determining structural color. The system may include a processor configured to execute machine readable instructions that cause the processor to: receive one or more input properties, wherein each of the one or more input properties is indicative of a property of an array of nanoparticles; receive one or more input parameters for an optical simulation; perform the optical simulation by applying a stochastic model of the array of nanoparticles according to the input parameters; and determine from the optical simulation an output optical parameter indicative of structural color.

In yet another aspect, there is a method for determining one or more properties of an array of nanoparticles according to desired target properties. The method may include: providing, to a processor, one or more target properties, wherein each of the one or more target properties is indicative of a desired optical property of an array of nanoparticles; providing, to the processor, one or more input parameters for an optical simulation; performing, by the processor, an evolutionary algorithm according to the input properties and input parameters, and wherein the evolutionary algorithm employs an optical simulation of the array of nanoparticles; and determining, by the processor, and from the evolutionary algorithm, an output design parameter indicative of one or more properties of the array of nanoparticles.

In still another aspect, there is an optimization system. The optimization system may include a processor configured to execute machine readable instructions that cause the processor to: receive one or more target properties, wherein each of the one or more target properties is indicative of a desired optical property of an array of nanoparticles; receive one or more input parameters for an optical simulation; perform an evolutionary algorithm according to the input properties and input parameters, and wherein the evolutionary algorithm employs an optical simulation of the array of nanoparticles; and determine an output design parameter from the evolutionary algorithm, the output design parameter being indicative of one or more properties of the array of nanoparticles.

The concepts described herein may be embodied as computer-implemented methods, non-transitory computer-readable storage mediums storing instructions executable by a processor, computing apparatuses, and bulk materials or other products prepared according to the disclosed methods, among other possibilities.

### BRIEF DESCRIPTION OF THE SEVERAL VIEWS OF THE DRAWINGS

FIG. 1A is a diagram illustrating optical processes that contribute to non-structural color of a material.

FIG. 1B is a diagram illustrating optical processes that contribute to structural color of a material.

FIG. 2A is a diagram illustrating geometric parameters for determining the scattering of constructively, and destructively, interfering light.

FIG. 2B is a diagram depicting an array of three nanoparticles each scattering light waves demonstrative constructive and destructive interference.

FIG. 3A is a scanning electron microscopy (SEM) image of a microsphere having a direct, ordered structure.

FIG. 3B is a scanning electron microscopy (SEM) image of a microsphere having an inverse, ordered structure.

FIG. 3C is a scanning electron microscopy (SEM) image of a microsphere having a direct, disordered structure.

FIG. 3D is a scanning electron microscopy (SEM) image of a microsphere having an inverse, disordered structure.

FIG. 4A is a diagram that illustrates a simulated light scattering model according to a stochastic model, such as a Monte Carlo model.

FIG. 4B is a diagram that illustrates a bulk scattering model wherein incident light is incident on, and propagates into, a bulk material.

FIG. 5 illustrates an exemplary environment suitable for performing simulation(s) as described herein.

FIG. 6 illustrates an example of applying the environment of FIG. 5 to generate a reflectance curve.

FIG. 7 is a block diagram of an environment with a parameter refinement process that accepts, as input, target values for the outputs of the environment of FIG. 5.

FIG. 8 illustrates an exemplary system 800 suitable for practicing the simulation of structural color, and the parameter optimization techniques.

FIG. 9 illustrates a method suitable for selecting parameters of an array of nanoparticles.

FIG. 10 illustrates exemplary a method suitable for tuning parameters of an array of nanoparticles.

FIG. 11 depicts an illustrative computer system architecture that may be used to perform simulations of structural color, and perform optimizations of parameters of nanoparticles.

### DETAILED DESCRIPTION

Embodiments described herein relate to techniques for determining optical properties of a nanoparticle or nanoparticle array and further to determining one or more structural properties of an array of nanoparticles that result in desired optical properties for a structural color of the array. The nanoparticle array may include, for example, an arrangement of nano-scale particles, a part of a single microsphere (a sphere measured at a micro-scale) made up of nanoparticles, or a bulk material including a plurality of microspheres. The techniques described herein may be used, for example, to produce the materials described in International Patent Application Publication No. WO 2019/051357, entitled “Microspheres Comprising Polydisperse Polymer Nanospheres and Porous Metal Oxide Microspheres” and filed on Sep. 10, 2018, and in International Patent Application Publication No. WO 2019/051353, entitled “Porous Metal Oxide Microspheres” and filed on Sep. 10, 2018. The contents of the aforementioned applications are incorporated by reference herein.

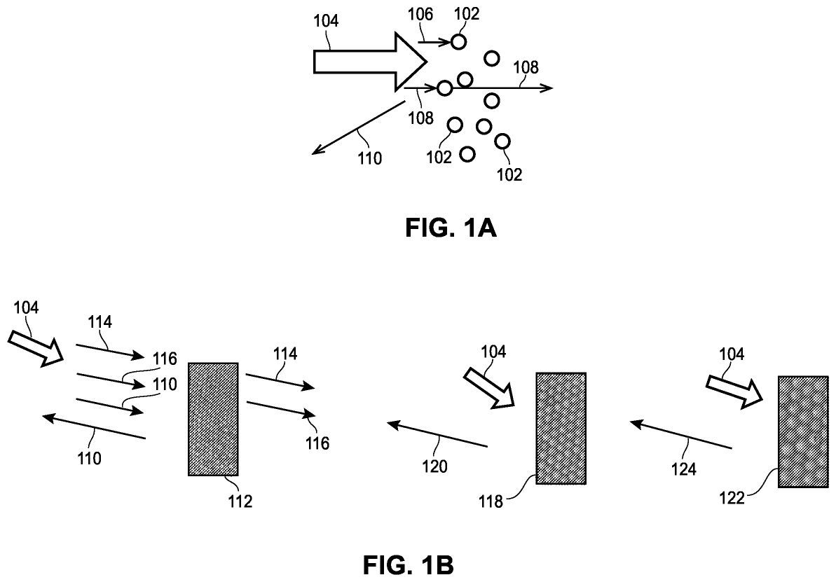

FIG. 1A is a diagram illustrating optical processes that contribute to non-structural color of a material, while FIG. 1B is a diagram illustrating optical processes that contribute to structural color of a material. As shown in FIG. 1A, a surface, liquid, aerosol, or other material may include a plurality of molecules 102. When incident white light 104, having a broadband of wavelengths, is directed at the molecules 102, some of the wavelengths of the white light 104 are absorbed, other wavelengths are scattered, and yet other wavelengths are transmitted by the plurality of molecules 102. The chemical properties of the molecules 102 determine which wavelengths of light are absorbed, which are scattered, and which are transmitted. For instance, in the example of FIG. 1A, the molecules 102 may absorb red light 106, transmit green light 108, and reflect or scatter blue light 110. Consequently, when a person looks at an object made up of the molecules 102, the object appears blue from the reflection of the blue light 110, or may appear green from the other side of the molecules 102 due to the transmission of the green light 108.

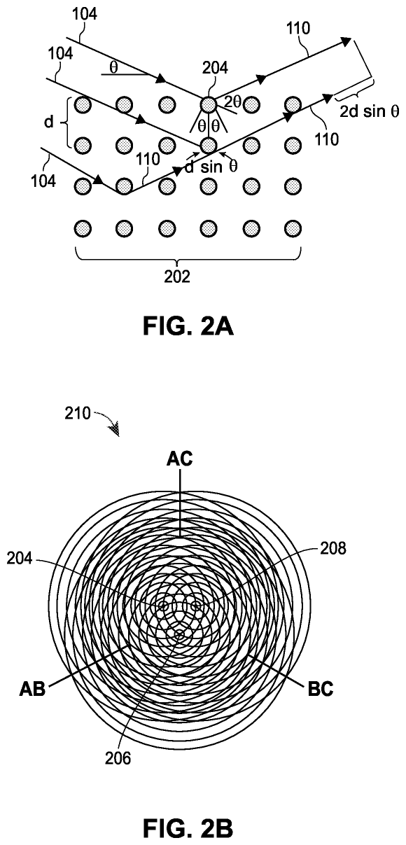

Structural color, as illustrated in FIG. 1B, is different from the chemically-induced color illustrated in FIG. 1A. Structural color can be caused by structures and geometries on the scale of the wavelengths of optical light (e.g., 400 to 800 nm). For example, structural color may be affected by the physical configuration of an array of nanoparticles. FIG. 1B depicts three nanoparticle arrays: a first array of nanoparticles 112, a second array of nanoparticles 118, and a third array of nanoparticles 122, with each array of nanoparticles having different physical properties. The physical properties of the first array of nanoparticles 112 cause some incident white light 104 to be transmitted (e.g., the red light 114 and the green light 116), while the blue light 110 is scattered. As described in more detail in connection with FIGS. 2A and 2B below, the scattered blue light 110 constructively interferes with itself, giving rise to a particular hue or shade of blue. By varying the physical properties of the first array of nanoparticles 112, the hue or shade can be altered.

The second array of nanoparticles 118 of FIG. 1B has a larger nanoparticle size as compared to the first array of nanoparticles 112. Consequently, the second array of nanoparticles 118 scatters green light 120 that constructively interferes with itself, instead of scattering the blue light 110. Similarly, the third array of nanoparticles 122, has an even larger nanoparticle size than the second array of nanoparticles 118, and the third array of nanoparticles scatters constructively-interfering red light 124.

FIG. 2A is a diagram illustrating geometric parameters for determining the scattering of constructively, and destructively, interfering light. FIG. 2A depicts an array of nanoparticles 202, with white light 104 being incident on a first nanoparticle 204 at an angle of incidence 0. The incident white light 104 is scattered by the first nanoparticle 204 and is reflected away from the array of nanoparticles 202 at a scattering angle that is equal to the angle of incidence θ. Further, the incident white light 104 may be scattered from other nanoparticles of the array of nanoparticles 202, either at a surface of the array of nanoparticles or within the array at a different layer of nanoparticles than the first nanoparticle 204.

FIG. 2B depicts an array of three nanoparticles each scattering light waves isotropically in the plane of the page. The illustration of FIG. 2B demonstrates constructive and destructive interference of scattered light from the nanoparticles. Light is incident on the first nanoparticle 204, a second nanoparticle 206, and a third nanoparticle 208. The light is scattered by the first, second, and third nanoparticles 204, 206, and 208. The scattered light waves are illustrated by the concentric rings of FIG. 2B, which each ring having a center at one of the first, second, or third nanoparticle 204, 206, or 208. The resulting aggregated scattered light gives rise to an interference pattern 210. The light waves constructively and destructively interfere at locations where two or more of the light waves are spatially overlapped. For example, the light scattered by the first and second nanoparticles 204 and 206 constructively interferes along the axis AB, light scattered by the second and third nanoparticles 206 and 208 constructively interferes along the axis BC, and light scattered by the first and third nanoparticles 204 and 208 constructively interferes along the axis AC. There are axes and locations where all scattered light from the three nanoparticles interferes constructively as well. Further, between the axes AB, BC, and AC, light scattered by the three nanoparticles 204, 206, and 208 includes regions of destructive interference, and may include areas having secondary, tertiary, and so on, constructive interference peaks. When a wavelength, or band of wavelengths, of light constructively interferes with itself, the amplitude of those wavelengths is increased, while destructively interfering wavelengths are dampened or filtered out.

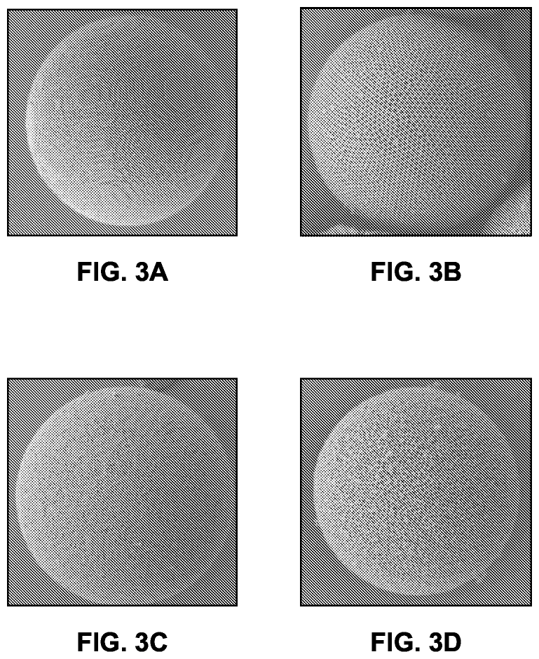

The interference pattern 210 may arise from different types of arrays of ordered or semi-ordered nanoparticles. For example, an array of nanoparticles may be an array of nanoparticles in a plane, or in a bulk material. In some embodiments an array of nanoparticles may be implemented as a microsphere made up of nanoparticles and having a particular type of structure and a bulk material may include a plurality of the microspheres containing the array of nanoparticles. FIGS. 3A through 3D are scanning microscope images of microspheres having nanoparticles with the microspheres having various structural properties. The microspheres shown have a direct, ordered structure (FIG. 3A), an inverse, ordered structure (FIG. 3B), a direct, disordered structure (FIG. 3C), and an inverse, disordered structure (FIG. 3D). The inverse structures of FIG. 3B include nanovoids confined within the microsphere. When modeling an inverse structure like a nanovoid, nanoparticles having a refractive index of 1 are used, which is the refractive index for air. Therefore, the nanoparticles shown in FIG. 3B are air which represents the nanovoids. A bulk material may include one or more of the microspheres of FIGS. 3A-3D to achieve a structural color of the bulk material. For example, a bulk material may be a dye, paint, coating, thin film, or other material having one or more of the microspheres having nanospheres as illustrated in FIGS. 3A-3D.

Each of the depicted types of structures of microspheres may have different structural color properties. For example, the ordered structures of FIGS. 3A and 3B may exhibit angle-dependent color, wherein the color observed is not the same from all angles but rather changes depending on the position of the viewer, the light source, and the sample of the ordered structures. That is, a structure that exhibits angle dependent color scatters different wavelengths of light that interfere constructive at different scattering, or reflation, angles. In contrast, the disordered structures of FIGS. 3C and 3D may exhibit angle-independent color, where the color observed is the same from all angles. That is, a same wavelength, or band of wavelengths, of light constructively interfere at all angles independent of the position of the light source, a viewer, or the sample of the disordered structures. The direct structures of FIGS. 3A and 3C may result from a three-dimensional shape of nanoparticles, or nanosurface elements (e.g., bumps, pyramids, cubes, a surface roughness, etc.) that extend outward from the microsphere, whereas the inverse structures of FIGS. 3B and 3D may result from a configuration where the surface of the microsphere is characterized by nanometer scale negative nanoparticle elements such as voids or negative spaces that extend inwards from the surface of the sphere. Polydispersity of the polymers in the nanoparticles, and surfaces of voids or negative nanoparticle elements, can give rise to disordered or semi-ordered structures, whereas monodispersity can give rise to ordered structures. In some cases, inverse structures may be more readily formulatable than direct structures, although embodiments contemplate the fabrication and use of both direct and indirect structures. It is noted, however, that not all ordered structures exhibit angle-dependent color, and not all disordered structures exhibit angle-independent color.

Table 1 below presents a listing of wavelengths of light, and the approximate nanoparticle size which can lead to constructive interference of the scattered wavelength of light, of inverse, ordered microspheres. The list of Table 1 may be useful for determining structural color parameters (e.g., void sizes) for a plurality of nanoparticles to reflect a specific wavelength of light. For example, void sizes between 200 and 240 nm may be useful for fabricating nanoparticles that scatter or reflect blue light, but further simulations and process may be required to tune the specific hue of blue, or wavelength as desired. Other features may also be useful for generating a scattered wavelength band and/or tuning the structural color of a material including void distances on a microspheres, concentrations of voids, concentrations of direct structures, sizes of direct structures, a randomized placement of voids or direct structures, periodicity of inverse or direct structures, a concentration of microspheres, or properties of a medium that contains the microspheres or nanoparticles, among others.

| Type | Name | Wavelength | Void Size |
|---|---|---|---|
| Ultraviolet | UV | 100-400 nm | 50-200 nm |
| Visible Light | Violet | 400-435 nm | 200-218 nm |
| | Blue | 435-480 nm | 218-240 nm |
| | Patina | 480-490 nm | 240-245 nm |
| | Blue Green | 490-500 nm | 245-250 nm |
| | Green | 500-560 nm | 250-280 nm |
| | Yellow Green | 560-580 nm | 280-290 nm |
| | Yellow | 580-595 nm | 290-298 nm |
| | Orange | 595-610 nm | 298-305 nm |
| | Red | 610-750 nm | 305-375 nm |
| | Dark Red | 750-800 nm | 375-400 nm |
| Infrared | IR | 800-10075 nm | 400-5038 nm |

The scattering of light from an array of nanoparticles can be computationally difficult to model. Although Mie theory provides an accurate solution that represents the scattering of light interacting with spheres having a length scale similar to optical wavelengths of light, via Maxwell's equations, a microsphere, as described herein, is a complex object that includes a plurality of nanospheres or nanostructures. Each such nanosphere or nanostructure may scatter light in different ways, and each may have many different properties that affect the resulting Mie scattering. Consequently, some models of light scattering are not practical, or are unable, to simulate the structural color resulting from light scattering from an array of nanoparticles.

One example modeling technique for determining structural color utilizes a single-scattering approximation in which light is only scattered once by a particle of an array of particles (e.g., by a microsphere, nanosphere, by a nanoscale feature of a surface or of a microsphere, etc.). As described herein, a single scattering model simulates Mie scattering from a single nanosphere, and determines the resulting interference as the scattered light interacts with scattered light from other nearby nanospheres. The single scattering model provides information that may be indicative of reflectance peak of a particular nanosphere, microsphere, or materials having nanometer sized features. Although relatively computationally simple, the single scattering model may not accurately account for scattering in complex systems where light scatters from multiple nanospheres and may interact with other scattered light. Even so, in some circumstances the single scattering model can provide a reasonable prediction of structural color properties, and may be well-suited for simulations performed on hardware having limited processing or memory resources.

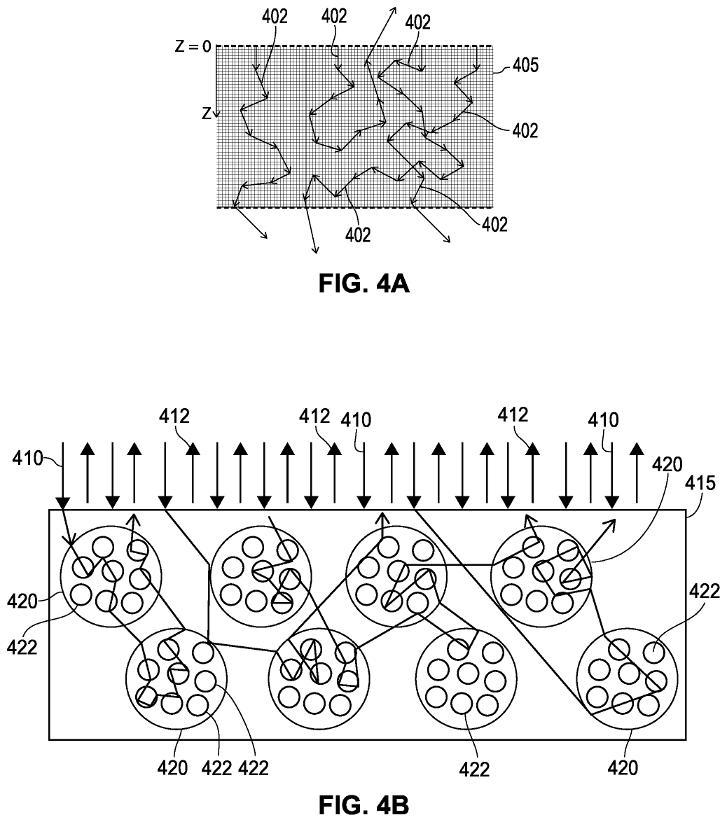

FIG. 4A is a diagram that illustrates a simulated light scattering model according to a stochastic model, such as a Monte Carlo model. The Monte Carlo model illustrated in FIG. 4A accounts for multiple scatterings of a plurality of light rays 402 as the rays 402 propagate through a medium 405. FIG. 4A illustrates that the light enters the medium 405 at the z=0 axis line, and the rays 402 propagate and scatter through the medium 405 until the rays 402 exit the medium 405 at the cutoff z axis, or at the z=0 axis. The medium 405 includes scattering elements which may include one or more microspheres, nanospheres, nanoscale surface features, voids, direct structures, indirect structures, or another scattering element or feature. The multiple scattering stochastic model depicted in FIG. 4A may be more accurate than a single scattering model while requiring only an intermediate level of computing resources. Still, the illustrated Monte Carlo model may not capture light scattering from bulk materials, or systems having numerous microspheres.

A bulk scattering model may be desired or required to determine properties of structural color of a material. An embodiment bulk model may determine a simulated reflectance from many microparticles using a two-tiered stochastic modeling approach FIG. 4B is a diagram that illustrates a bulk scattering model wherein incident 410 light is incident on, and propagates into, a bulk material 415. The bulk material 415 includes a plurality of microspheres 420, with each microsphere 420 having a plurality of nanometer scattering elements 422. Each of the nanometer scattering elements 422 may be one or more of a nanoparticle, a nanometer scale surface feature, a direct structure, an inverse structure, an ordered structure, a disordered structure, or another scattering element. The light 410 may scatter from one or more of the microspheres 420, and one or more of the nanometer scattering elements 422 multiple times before the light propagates out of the medium 415 as reflected light 412. Further, the bulk model may consider absorption of the light 410 and transmission of the light 410. Although a bulk model may require more computational resources than the single-tier scattering stochastic model or the single-scattering model, the accuracy of the predicted structural color may be improved due to the fact that the bulk model may account for properties of a bulk system.

As illustrated in FIG. 4B, and as described herein, a bulk material may be considered to include a plurality of microspheres, with each microspheres containing a plurality of nanometer scale elements, or nanoparticles. It is envisioned that the described simulation and optimization techniques may be applied to other types of bulk materials and mediums as well. For example, the disclosed methods and systems may be implemented with a bulk material containing a plurality of nanoparticles, a medium with one or more arrays of nanoparticles, a medium with one or more arrays of microparticles, a medium containing microscale and/or nanoscale scatterers, or another bulk medium capable of scattering light by microscale and/or nanoscale features.

Within a given model, various parameters may be provided for a simulation, with each parameter affecting the simulation of one or more phenomena of visible light. Each parameter may affect one or more properties of structural color of a material. A parameter may include one or more numerical values, boundary conditions, a set of values for a given variable, a number of iterations, a statistic of interest, or another type of input parameter. The phenomena of light may include, for example, a boundary condition for light scattering e.g., a spherical boundary condition, a planar boundary condition, etc.), polydispersity and mixtures of nanoparticles , light polarization, light absorption, a surface roughness, an index of refraction, a nonlinear optical coefficient, a birefringence, or an angle-dependence (e.g., a reflectance curve angle dependence, an angle dependence of a filter, an angle dependence of a grating, etc.), among others. The phenomena, and others, may be accounted for when performing a simulation using one of the above-described models.

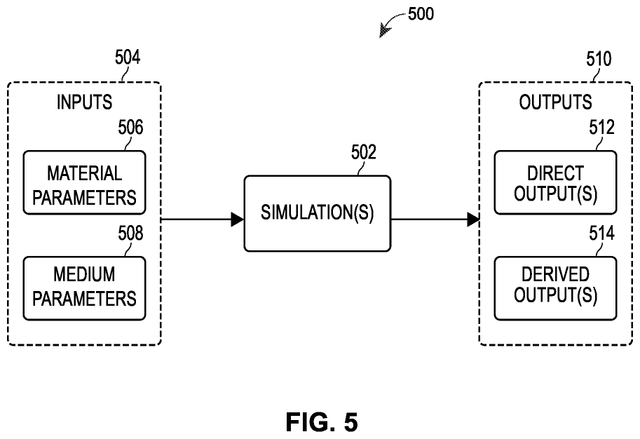

For instance, FIG. 5 illustrates an exemplary environment 500 suitable for performing simulation(s) 502 as described herein. In the environment 500, one or more inputs 504 may guide the simulation(s) 502. The inputs 504 may include various types of inputs, such as material synthesis parameters 506 that relate to the physical properties of the nanoparticles and/or one or more medium parameters 508 that relate to the properties of a grouping of nanoparticles. The one or more medium parameters 508 may include parameters pertaining to a medium that the nanoparticles are suspended in, enveloped by, or that the nanoparticles are otherwise within boundaries of the medium. Examples of material synthesis parameters 506 include, but are not limited to, optical parameters and/or structural parameters such as a surface roughness, a complex refractive index of a matrix material, an absorption of the matrix material, a dopant for the matrix material, a microparticle or nanoparticle size, a material of a nanoparticle, a volume fraction of nanoparticles, a void size, a polydispersity of nanoparticles or microparticles, or an absorber amount, a direct structure size, an inverse structure size, a nanoparticle shape/geometry, a nanoparticle shell parameter such as a shell thickness or shell material, a nanoparticle porosity, a surface feature of a nanoparticle, a lattice constant of a plurality of nanoparticles, a concentration of nanoparticles in a medium, or another parameter pertaining to a physical feature of synthesis of a material. Examples of medium parameter 508 include, but are not limited to, a type of a medium, a material of a medium, a complex refractive index of the medium, a microsphere concentration, a microsphere mixture, an absorber amount, an absorber concentration, a thickness of the array of nanoparticles, or a degree of order of the array of nanoparticles.

The inputs 504 may be provided to the simulation(s) 502, which may use the inputs 504 and a light scattering model (e.g., a bulk model, Monte Carlo model, single scattering model, a stochastic model, etc.) in order to determine approximations of various properties of visible, or non-visible, light scattered by the simulated array of nanoparticles, a bulk material, or another medium. The result of the simulation may be outputs 510. The outputs 510 may include direct output(s) 512, such as a reflectance of the array of nanoparticles at a specified wavelength or angle, or a transmittance of the array of nanoparticles at the specified wavelength. The outputs 510 may further include derived output(s) 514, which may involve multiple runs of the simulation(s) 502 in order to determine derived values of parameters. Examples of derived output(s) 514 include a reflectance curve of the array of nanoparticles, a resonance wavelength of the array of nanoparticles, an angle-dependent reflection of the array of nanoparticles, an absorption curve of the array of nanoparticles, a transmission curve of the array of nanoparticles, a range of wavelengths, a speckle amount, a scattering parameter, a target transport length, an angle independence, or a structural color of the array of nanoparticles.

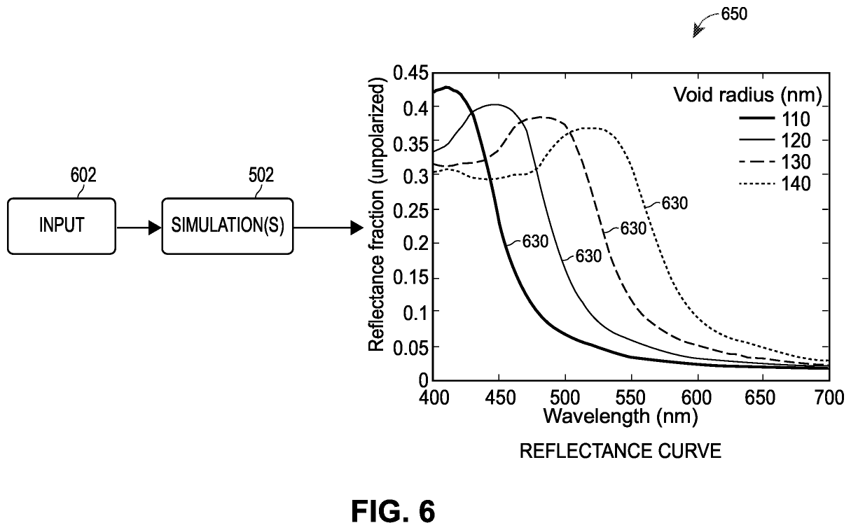

FIG. 6 illustrates an example of applying the environment 500 to generate a reflectance curve according to an exemplary embodiment. In this example, a particular set of input 602 parameters are provided and tested in multiple simulation(s) 502. For instance, a single simulation run may test the input 602 at a given wavelength, and multiple simulation runs may be used to test the input 602 over a range of wavelengths. The resulting reflectance at each tested wavelength may be used to generate a derived output in the form of a reflectance curve 630 which may be plotted and presented as shown on plot 650. Further, as shown on plot 650 of FIG. 6, the set of input parameters 602 may include a set of void sizes or void radii. The simulations 502 may be performed for a plurality of wavelengths (e.g., 400 to 700 nm) for each void size of a microparticle and a reflectance curve 630 may be determined for each void size across a range of wavelengths. While illustrated as one or more reflectance curves 730, the outputs 510 of the simulations 602 may be one or more other parameters of structural color.

The simulation procedure outlined above, for determining structural color properties of a material or an array of nanoparticles, may also be useful for determining physical and structural properties of materials to generate a target structural color. For example, in reference to FIG. 5, target outputs 510 may be identified, and an evolutionary optimization process may be performed to refine inputs 504 to achieve the target outputs 510.

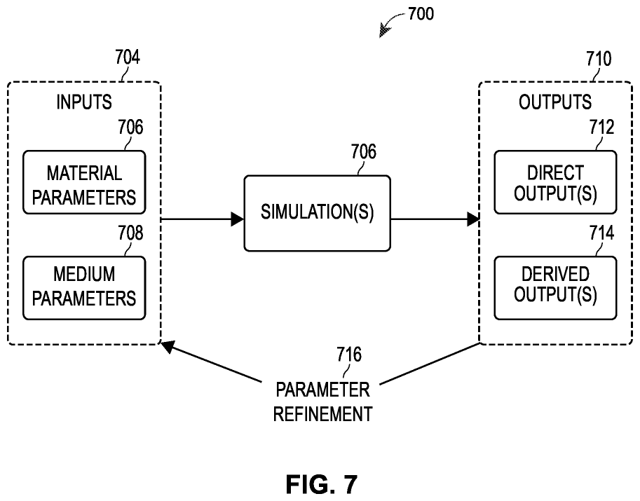

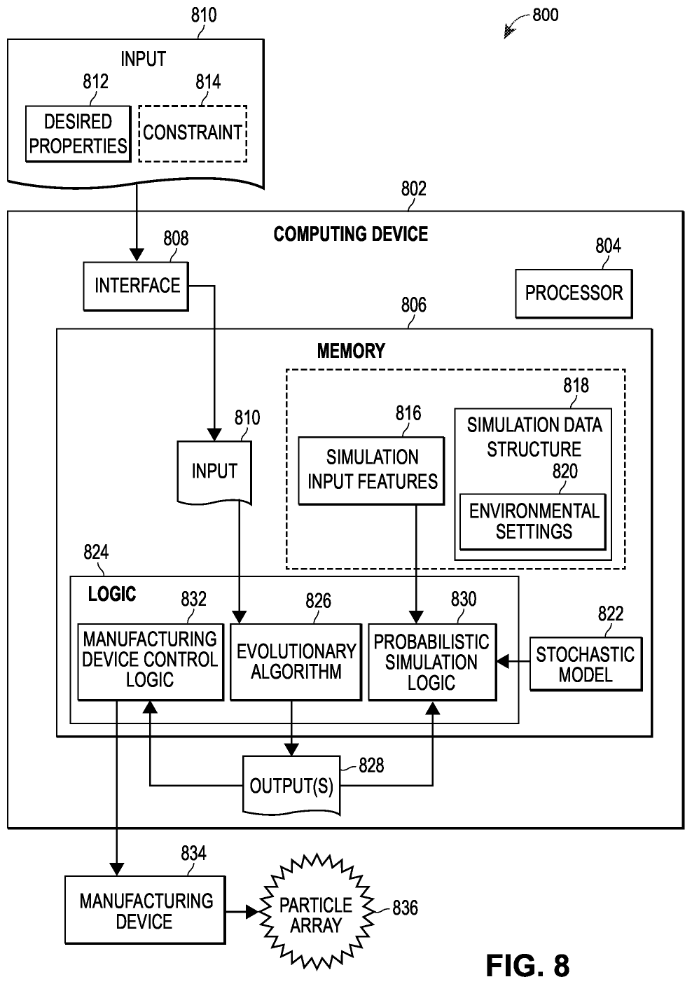

FIG. 7 is a block diagram of an environment 700 including a parameter refinement process 716 that accepts, as input, target values for the outputs 710. The parameter refinement process then selects and/or varies different inputs 704 and provides the inputs to the simulation(s) 702 in order to determine which combination of inputs 704 gives rise to the specified outputs 710. The simulations 702 may include one or more single-scattering simulation, multiple-scattering method, bulk method, another stochastic simulation or another simulation. An exemplary parameter refinement process 716 is described below in more detail with respect to FIGS. 8-10.

Turning now to a procedure for tuning parameters of an array of nanoparticles in order to achieve specified structural color properties, FIG. 8 illustrates an exemplary system 800 suitable for practicing exemplary embodiments.

The system 800 includes a computing device 802, which may be any computing device suitable for performing the processes identified below. For example, the computing device 802 may be a server, a desktop computer, a laptop, a tablet or mobile computing device, or a special-purpose computing device specifically configured to perform the identified processes. The computing device 802 may include a hardware processor 804 for executing machine executable instructions to perform 824 embodying the procedures and methods described herein. Although the illustrative computing device 802 is depicted as a single device, it is understood that the illustrated components may be distributed across multiple devices, and components illustrated as a single entity in FIG. 8 (e.g., the probabilistic simulation logic 830) may be divided between multiple computing devices.

The computing device 802 may include a memory 806, which may be a non-transitory computer-readable medium (such as RAM or ROM). Information or data may be added to the memory 806 via an interface 808 (or multiple interfaces), such as a network interface (e.g., a network interface card, Ethernet adapter, etc.), a keyboard, a mouse, a microphone, a camera, etc.

An input 810 may be provided to the interface 808. The input 810 may provide various details that drive or configure a parameter refinement process. For instance, the input 810 may specify one or more desired properties 812 of a structural color of an array of nanoparticles for at least one wavelength of light.

For example, the desired properties may include a target reflectance of the array of nanoparticles at a specified wavelength or angle, or a target transmittance of the array of nanoparticles at the specified wavelength. In some embodiments, the desired properties may include complex or derived properties, such as a target reflectance curve of the array of nanoparticles, a target resonance wavelength of the array of nanoparticles, a target angle-dependent reflection of the array of nanoparticles, a target angle independent characteristic, a scattering amount, a target absorption value or curve of the array of nanoparticles, a target transmission value or curve of the array of nanoparticles, or a target structural color of the array of nanoparticles. Exemplary embodiments can accommodate such complex/derived properties by running a probabilistic simulation multiple times (e.g., once at each wavelength, angle, etc.).

In some cases, it may be impossible or undesirable to modify one or more of the parameters of the array of nanoparticles. For example, due to constraints of a manufacturing device 834 that is used to produce a material including the array of nanoparticles. The manufacturing device 834 may not be capable of producing nanoparticles having a certain void size, may not have access to certain materials, or may not be capable of achieving a surface roughness beyond a given threshold, etc. Accordingly, the input 810 may further specify a constraint 814 that specifies values that a parameter is permitted to take, or specifies values that the parameter is not permitted to take. In some embodiments, the constraint 814 may be a hard constraint that cannot be violated (i.e., the parameter refinement process is restricted from violating the constraint 814). In others, the constraint 814 may be a soft constraint that can be violated under certain conditions (e.g., when violating the parameter yields a disproportionately large increase in achieving the desired properties, or when the desired properties cannot be achieved without violating the constraint 814).

The memory 806 may further store simulation input features 816 used to define or guide the simulation. The simulation input features 816 may include a parameter for the stochastic model, a Fresnel reflection approach, a complex refractive index dispersion equation, a number of Monte Carlo trajectories, a number of Monte Carlo events, an effective medium approximation strategy, or a selection for a type of the array of nanoparticles.

The memory 806 may further store a simulation data structure 818 that defines an environmental setting 820 for the probabilistic simulation. The environmental setting may be, for example, a boundary condition, a polarization, or a medium for the array of nanoparticles. The simulation data structure 818 may be applied when conducting the probabilistic simulation on the array of nanoparticles to determine one or more simulated properties of the structural color of the array of nanoparticles.

In order to determine how visible (or non-visible) light interacts with an array of nanoparticles, a stochastic model 822 of the scattering of the light may be applied, as described above. In some embodiments, the stochastic model may be a Monte Carlo model.

In order to select or refine the parameters, instructions executable on the processor 804 may be stored in the memory 806 in the form of logic 824. For instance, the logic 824 may include an evolutionary algorithm 826, probabilistic simulation logic 830, and/or manufacturing device control logic 832.

The evolutionary algorithm 826 may be an algorithm for refining the parameters of the array of nanoparticles using mechanisms corresponding to biological evolutionary principles (e.g., reproduction, mutation, recombination, and selection). The evolutionary algorithm 826 may be a population-based optimization algorithm. The evolutionary algorithm 826 may be a non-gradient-based evolutionary algorithm that does not rely on a gradient of the objective function when refining the parameters. One example of a non-gradient-based evolutionary algorithm is a differential evolution algorithm that iteratively improves the parameters with respect to a cost function. In embodiments, the evolutionary algorithm may include a maximum likelihood optimization, a differential evolution algorithm, a Bayesian optimization, a genetic algorithm, a covariance matrix adaptation evolution strategy, a particle swarm optimization, and simulated/or annealing.

The evolutionary algorithm 826 may generate one or more output(s) 828 representing values for the parameters of the array of nanoparticles. The output(s) 828 may be evaluated by probabilistic simulation logic 830, which runs a probabilistic simulation of an array of nanoparticles having properties corresponding to the output(s) 828 using the stochastic model 822. The results of the probabilistic simulation may be fed back to the evolutionary algorithm 826 (e.g., to be analyzed in connection with a cost function) to determine whether the evolutionary algorithm 826 is improving the parameters with respect to the desired properties 812.

When a stopping condition is met, the evolutionary algorithm 826 may generate a final set of output(s) 828. The stopping condition may include a value associated with a cost function, a statistic of interest, a difference between one or more inputs 810 and one or more of the outputs 828, a number of iterations of the evolutionary algorithm, or another stopping condition. Optionally, the output(s) 828 may be provided to the manufacturing device control logic 832, which may be configured to control a manufacturing device 834 to produce material including an array of nanoparticles 836 having parameters corresponding to the output(s) 828. For example, the manufacturing device 834 may be configured to produce a bulk material including one or more of a dye, paint, or coating including an array of nanoparticles having structural and physical features corresponding to the output(s) 828.

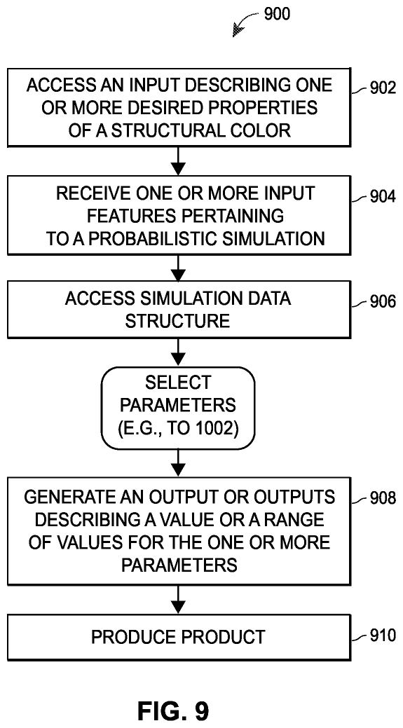

FIG. 9 illustrates a method 900 for selecting parameters of the array of nanoparticles in accordance with an embodiment.

In block 902, the method 900 may access an input describing one or more desired properties of a structural color of an array of nanoparticles for at least one wavelength of light. The array of nanoparticles may be, for example, an arrangement of nanoparticles (such as a sheet or plane), a part of a microsphere, or a bulk material comprising a plurality of microspheres. The bulk material may be a dye, ink, paint, coating, or another material medium that contains the plurality of microspheres, and/or a plurality of nanospheres.

In block 904, the method 900 may include receiving one or more input features pertaining to a probabilistic simulation of a behavior of the light applied to the array of nanoparticles. The probabilistic simulation may apply a stochastic model of the array of nanoparticles.

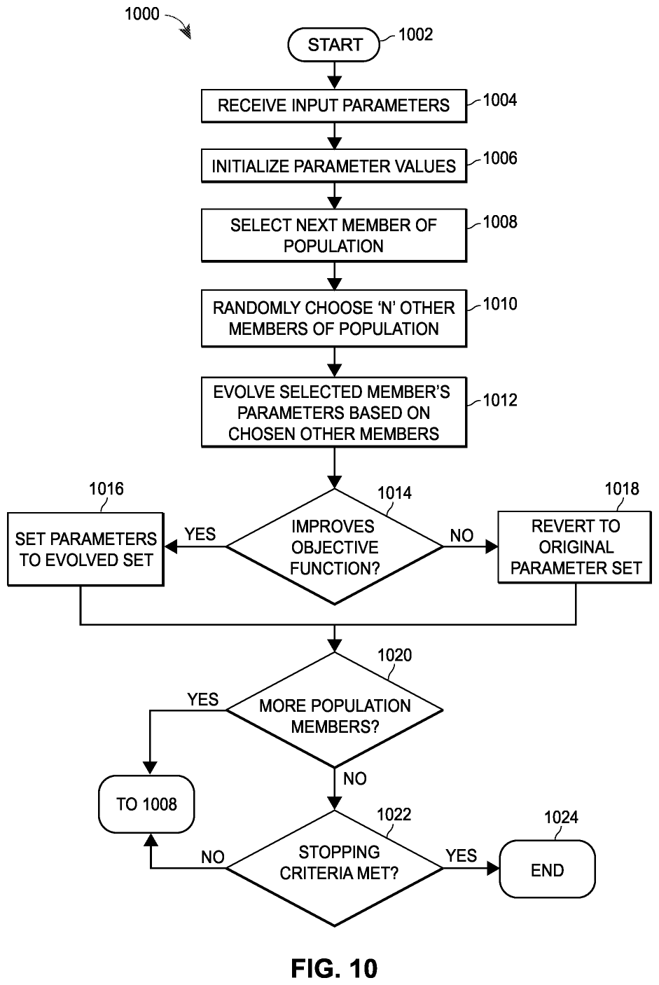

In block 906, the method 900 includes accessing a simulation data structure defining an environmental setting for the probabilistic simulation. The environmental setting may be, for example, a boundary condition, a polarization, or a medium for the array of nanoparticles. The simulation data structure may be used to conduct the probabilistic simulation on the array of nanoparticles to determine one or more simulated properties of the structural color of the array of nanoparticles, as described in more detail in connection with FIG. 10. For instance, the probabilistic simulation may be run using the one or more input features to quantitatively predict observable color structure features of the array of nanoparticles. By applying an optimization technique such as a differential evolution algorithm, the probabilistic simulation may be implemented over multiple iterations and one or more parameters of the array of nanoparticles may be adjusted for each iteration to approximate the desired properties of the structural color.

At block 908, based on applying the stochastic model, the method 900 generates an output indicative of a single value, multiple values, or a range of values for the one or more parameters of the array of nanoparticles to approximate the desired properties of the structural color for the at least one wavelength of light.

At block 910, the method 900 may include controlling machinery to produce a product including an array of nanoparticles having parameters that have been determined using the above-described process according to the method 900. For example, the machinery may produce a dye, a paint, or a coating comprising the array of nanoparticles.

Structural color arising from nanoparticles can result in especially bright, saturated colors that appear very similar to colors produced by more conventional dyes, paints, and coatings that rely on absorption to produce a color. Accordingly, conventional dyes, paints, and coatings can readily be replaced with similar products incorporating structural color, which has a number of advantages over absorption-based color. Structural color resists photobleaching and may be less photoreactive. Moreover, different structural colors can be made from the same base materials by changing the properties of the nanoparticles (e.g., the size of the voids and/or the size of the particles). As a result, a user can first select the component materials that will be used to make a particular color, based on non-color properties (e.g., toxicity, reactivity, etc.), and can then produce different colors from those materials by altering the properties of the nanoparticles.

FIG. 10 illustrates a method 1000 for tuning the parameters of an array of nanoparticles according to an exemplary embodiment. The method 1000 applies a differential evolution algorithm, which is one example of a non-gradient-based evolutionary algorithm. In evolutionary algorithms generally, and differential evolution algorithms specifically, one or more parameters are optimized based on an objective function (e.g., a minimization function, maximization function, difference value, hit target, etc.) that is improved in a series of iterations. At each iteration, decision variables are updated (i.e., evolved) through various rules and heuristics, depending on the algorithm.

In differential evolution, each parameter set is modified based on a set of rules (e.g., a percent change, a random change, a perturbation, a weighted difference modification, a modification by one or more factors, etc.), and depending on the improvement of the objective function with these changes, the modified parameter set is either rejected or accepted. The set of rules may be akin to biologic evolution. For instance, a particular parameter may be randomly combined with values in other parameter sets (i.e., crossover). This may be performed at every iteration, leading to a new population of parameter sets for subsequent evaluation. The iterations halt after a stop point (e.g., a user-defined stopping criterion, predetermined number of iterations, etc.). Differential evolution is useful for optimizing parameters for systems with continuous parameter sets, a large number of variables, and objective functions.

Differential evolution may be implemented to optimize structural color parameters. The ultimate goal in structural color design is often to achieve a targeted structural color (e.g., reflectance spectrum) by varying the various physical and optical parameters of the structural color material. The combination of differential evolution and the above-described probabilistic simulation may be implemented to determine parameters of nanoparticles and materials to achieve a desired structural color. In an example, probabilistic simulation logic may be embedded into a differential evolution framework. First, a user may enter a target reflectance spectrum (e.g., reflectance values at given wavelengths). Other inputs may include: (1) one or more parameters of interest to vary to achieve the target; (2) for said parameters, the range to be explored; and (3) differential evolution parameters. Using the inputs, the differential evolution algorithm may initialize various parameter sets. For each parameter set, the stochastic model may be executed and may use the parameter values to predict reflectance at specified wavelengths. The system may compare the determined output reflectance spectrum to the target reflectance spectrum. The system may determine a difference between the output reflectance spectrum and the target reflectance spectrum as an objective function value for a specific parameter set. The system may execute the stochastic model for each parameter set in the population to determine output reflectance spectrums for each parameter set. The differential evolution algorithm may then update a family of structural color parameter sets via the rules outlined above (e.g., perturbation, percent change, weighted change values, etc.), and a next iteration of the evolution optimization may be performed. Through subsequent iterations, the objective function may be minimized to reduce the difference between the output and target reflectance spectra. At a stopping point (e.g., number of iterations, threshold of a cost or objective function, etc.) one or more output spectra, and the optimized physical and optical parameters and associated values to achieve the output spectra, may be recorded. The differential evolution optimization procedure described above is discussed in more detail below with reference to the method 1000.

Referring simultaneously to both FIGS. 8 and 10, the method 1000 begins at block 1002. Processing may proceed to block 1004, where the system receives a set of input parameters, which may include a list of parameters to be optimized, maximum and/or minimum values for the parameters, etc. The parameters may correspond to parameters of the array of nanoparticles that can be changed in order to affect the structural observable color of the array of nanoparticles (e.g., structural parameter values, structural features, optical parameter values, etc.). The parameters of the array of nanoparticles may include, but are not limited to, material synthesis parameters that relate to the physical properties of the nanoparticles and/or medium parameters that relate to the properties of a grouping of nanoparticles. Examples of material synthesis parameters include, but are not limited to, optical parameters and/or structural parameters including a surface roughness, a complex refractive index of a matrix material, an absorption of the matrix material, a dopant for the matrix material, a microparticle or nanoparticle size, a volume fraction of nanoparticles, a void size, a polydispersity of particles, an absorber amount, a nanoparticle shell parameter (e.g., a shell thickness and/or a material of the shell), a nanoparticle shape/geometry, a direct structure size, an indirect structure size, nanoparticle porosity, a surface feature of a nanoparticle, a lattice constant of a plurality of nanoparticles, a concentration of nanoparticles in a medium, or another parameter pertaining to a physical, optical, or electrical feature of a material. Examples of medium parameters include, but are not limited to, a type of a medium, a complex refractive index of the medium, a microsphere concentration, a microsphere mixture, an absorber amount, an absorber concentration, properties of the absorber, a thickness of the array of nanoparticles, a thickness of a bulk material made up of the array of nanoparticles, a thickness of a microsphere made up of the array of nanoparticles, a thickness of a bulk material made up of microspheres, or a degree of order of the array of nanoparticles. The properties of the absorber may include, for example, optical parameters such as an absorption coefficient or complex refractive index dispersion behavior of the absorber.

At block 1006, the parameter values are initialized. A population of M members is established, where M is an integer value, which may be predetermined or may be dynamically determined based on, for example, currently available processing resources. Each member of the population may be associated with a set of the parameters where each of the parameters in the set, for a given member, may have a different value as compared to a corresponding parameter for a different member of the population. The parameter values may be initialized (e.g., randomly, taking into account the acceptable minimum and maximum values, assigned or input by a user, etc.) for each member of the population.

In some embodiments, an input, such as the input 810 of FIG. 8, may specify a starting parameter space in which parameters may be further refined. A starting parameter space may be particularly useful, for example, if a user has identified a set of parameters giving rise to a particular color, but wishes to further refine one or more properties of the color (e.g., making the color more saturated, change the hue). Accordingly, when initializing the parameters at block 1006, the method 1000 may include selecting parameter values that fall within the identified starting parameter space. If a starting parameter space is identified for some, but not all, parameters, then those parameters for which a starting parameter space has been identified may be initialized within that space, and the remaining parameters may be initialized randomly or by another means. The parameters may be permitted to leave the starting parameter space or may be constrained to remain within the starting parameter space, depending on the application.

At block 1008, the system begins to evolve the parameter values for a given member of the population. The next member of the population, or the first member, during the first iteration of the algorithm, is selected for processing.

At block 1010, the system randomly chooses n other members of the population whose parameters will be used to evolve the selected member's parameter values. In one embodiment outlined in the pseudocode below, the value of n may be three.

At block 1012, the system evolves the selected member's parameter set based on corresponding parameter values of the other chosen members. Evolving the parameters may involve combining the chosen members' parameter values based on a function, with the possibility of including a random element, through random perturbation, or by another evolution rule or process. An example of evolving the selected member's parameter is provided in the pseudocode below. Block 1012 may be performed for each parameter in the parameter set.

In block 1012, the system may optionally enforce the constraint 814, or multiple constraints, when adjusting the parameter values. In addition to “box constraints” (i.e., min/max limits on each parameter), differential evolution is also capable of handling other various types of constraints, such as constraints on combinations of parameters. For example, a constraint may enforce certain size range when a certain material is used, but a different size range when another material. In some embodiments, constraints may be “soft constraints” that can be violated only if the resulting improvement in the objective function exceeds a predetermined threshold. Soft constraints allow a constraint to be violated, but requires that the benefit accrued from violating the constraint be worth the associated cost.

At decision block 1014, the system determines whether the evolved parameter set improves an objective function as compared to the previous version of the parameter value assigned to the member. The objective function may be a function that accepts a parameter set and an objective (e.g., the desired properties of visible light scattered by the array of nanoparticles, as defined in the input 810) and applies a probabilistic simulation using a stochastic model based on the parameter set. The probabilistic simulation may account for the particular form of the array of nanoparticles (e.g., nanoelements of a single microsphere, of bulk microspheres). The objective function may rank, score, or otherwise assign a quantitative value representing how closely an array of nanoparticles having the parameters defined by the parameter set matches the desired properties of the visible light.

Among other possibilities, the objective function may be applied to reduce undesired light scattering by the array of nanoparticles, the undesired light scattering represented as a cost function that is minimized by evolutionary optimization, maximize reflectance at a specified wavelength, reduce reflectance of undesired light at unspecified wavelengths, or maximize light scattering over visible wavelengths. The objective function may determine these quantitative values via the probabilistic simulation.

If the determination at decision block 1014 is “YES,” then processing may proceed to block 1016 and the system may set the parameter values for the current member to the evolved values determined in block 1012. If the determination at decision block 1014 is “NO,” then processing may proceed to block 1018, and the parameter values may revert to their original, unevolved values. Processing may then proceed to decision block 1020.

At decision block 1020, the system may determine if additional population members remain to be evaluated. If so, processing reverts to block 1008 and the next member of the population is selected. If not, processing proceeds to decision block 1022, and the system determines whether a predefined stopping criteria has been met. The predefined stopping criteria, also referred to as a stop condition, may include, for instance, whether a predetermined number of iterations have been performed, whether a predetermined amount of time has elapsed, whether the objective function rises or falls to a predetermined threshold indicating that an acceptable solution has been found, or whether the improvement between evolutions of the parameter values is increasing or decreasing at a predefined rate, indicating that the parameter values are not improving over the previous m iterations, a determination of stagnation of the objective function over a predefined number of iterations, among other possibilities. If the stopping criteria has not yet been met, then processing may revert to block 1008 and the system may revert back to the first member of the population. Otherwise, processing may proceed to block 1024 and terminate.

A particular implementation of the method 1000 may be represented by the following pseudocode:

```
Set input parameters to algorithm
  M = number of members of the population (number of parameter
  set candidates) [symbol]
  = number of iterations
  CR = crossover probability (ranging from 0 to 1, inclusive)
  F = differential weight (ranging from 0 to 2, inclusive)
Initialize the parameter values of each member of the population
(with p number of parameters (dimension of p))
For i = 1 : [symbol]
  For j = 1: M
    Choose, at random, 3 other (distinct) members of the
    population (m [symbol] , m [symbol] , m [symbol] )
    Choose, at random, an index (L) from 1:p
    Calculate member [symbol]  potentially new parameter set, n
      For k = 1: [symbol]
        Choose a uniform random number r [symbol]  (r [symbol] [symbol]   U(0,1))
        If r [symbol]  < CR or k = L
          set [symbol]  (kth parameter of potentially
          new jth member) according to : [symbol]  =
          m [symbol]  + F [symbol]  (m [symbol] m [symbol] )
        Else
          Do nothing
    Calculate objective function (f) for member n [symbol] . If
    f (n [symbol] ) ≤f (m [symbol] ), replace the m [symbol]  with the new n [symbol] [symbol]
indicates data missing or illegible when filed
```

There are numerous benefits to the described evolutionary optimization based determination of nanoparticle properties. First, in general, evolutionary algorithms are not gradient based, and therefore do not have to rely on the gradient of the objective function, which can often be costly in computational resources to update and improve. Furthermore, they do not assume anything about the objective function, and can handle challenging systems, including those that are multi-modal, stochastic, and non-differentiable. Also, the described evolutionary optimization based approach attempts to find the global, as opposed to the local, optimum. Specifically, differential evolution also has the advantage that it can determine multiple solutions instead of a single solution, which is useful when the practitioner cannot use the “best” solution for numerous reasons-including feasibility issues, cost constraints, a fabrication constraint, etc.—which may not have been included in the optimization algorithm.

In some embodiments, the parameter tuning method 1000 may be employed to effect a color that is the result of a mixture of different types of arrays of ordered or semi-ordered nanoparticles. For example, a first microsphere exhibiting a first set of structural color properties may be mixed with a second microsphere exhibiting a second set of structural color properties. The mixture may be associated with scattered light representing a mixture of the first and second structural color properties, resulting in a third structural color different than either of the constituent first or second structural colors. The properties of the third structural color may be measured and used to guide parameter selection using the method 1000. In this way, the method 1000 may select parameters for a single array of nanoparticles that exhibit the third structural color without relying on the combination of the first and second microspheres.

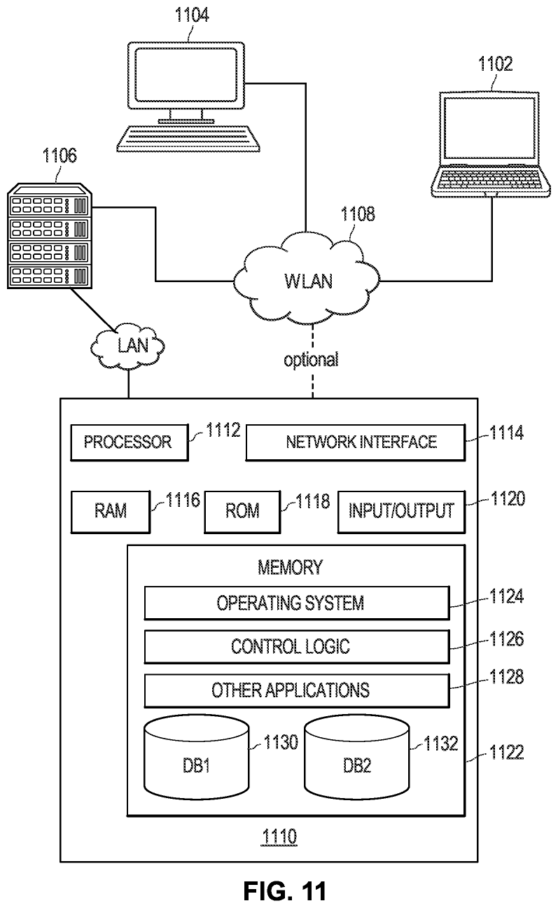

FIG. 11 illustrates one example of a system architecture and data processing device that may be used to implement one or more illustrative aspects described herein in a standalone and/or networked environment. Various network nodes, such as the data server 1110, web server 1106, computer 1104, and laptop 1102 may be interconnected via a wide area network 1108 (WAN), such as the internet. Other networks may also or alternatively be used, including private intranets, corporate networks, LANs, metropolitan area networks (MANs) wireless networks, personal networks (PANs), and the like. Network 1108 is for illustration purposes and may be replaced with fewer or additional computer networks. A local area network (LAN) may have one or more of any known LAN topology and may use one or more of a variety of different protocols, such as ethernet. Devices data server 1110, web server 1106, computer 1104, laptop 1102 and other devices (not shown) may be connected to one or more of the networks via twisted pair wires, coaxial cable, fiber optics, radio waves or other communication media.

Computer software, hardware, and networks may be utilized in a variety of different system environments, including standalone, networked, remote-access (aka, remote desktop), virtualized, and/or cloud-based environments, among others.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity--which resides across all physical networks.

The components may include data server 1110, web server 1106, and client computer 1104, laptop 1102. Data server 1110 provides overall access, control and administration of databases and control software for performing one or more illustrative aspects described herein. Data server 1110 may be connected to web server 1106 through which users interact with and obtain data as requested. Alternatively, data server 1110 may act as a web server itself and be directly connected to the internet. Data server 1110 may be connected to web server 1106 through the network 1108 (e.g., the internet), via direct or indirect connection, or via some other network. Users may interact with the data server 1110 using remote computer 1104, laptop 1102, e.g., using a web browser to connect to the data server 1110 via one or more externally exposed web sites hosted by web server 1106. Client computer 1104, laptop 1102 may be used in concert with data server 1110 to access data stored therein, or may be used for other purposes. For example, from client computer 1104, a user may access web server 1106 using an internet browser, as is known in the art, or by executing a software application that communicates with web server 1106 and/or data server 1110 over a computer network (such as the internet).

Servers and applications may be combined on the same physical machines, and retain separate virtual or logical addresses, or may reside on separate physical machines. FIG. 11 illustrates just one example of a network architecture that may be used, and those of skill in the art will appreciate that the specific network architecture and data processing devices used may vary, and are secondary to the functionality that they provide, as further described herein. For example, services provided by web server 1106 and data server 1110 may be combined on a single server.

Each component data server 1110, web server 1106, computer 1104, laptop 1102 may be any type of known computer, server, or data processing device. Data server 1110, e.g., may include a processor 1112 controlling overall operation of the data server 1110. Data server 1110 may further include RAM 1116, ROM 1118, network interface 1114, input/output interfaces 1120 (e.g., keyboard, mouse, display, printer, etc.), and memory 1122. Input/output interfaces 1120 may include a variety of interface units and drives for reading, writing, displaying, and/or printing data or files. Memory 1122 may further store operating system software 1124 for controlling overall operation of the data server 1110, control logic 1126 for instructing data server 1110 to perform aspects described herein, and other application software 1128 providing secondary, support, and/or other functionality which may or may not be used in conjunction with aspects described herein. The control logic 1126 may also be referred to herein as the data server software control logic 1126. Functionality of the data server software may refer to operations or decisions made automatically based on rules coded into the control logic 1126, made manually by a user providing input into the system, and/or a combination of automatic processing based on user input (e.g., queries, data updates, etc.).

Memory 1122 may also store data used in performance of one or more aspects described herein, including a first database 1132 and a second database 1130. In some embodiments, the first database may include the second database (e.g., as a separate table, report, etc.). That is, the information can be stored in a single database, or separated into different logical, virtual, or physical databases, depending on system design. Web server 1106, computer 1104, laptop 1102 may have similar or different architecture as described with respect to data server 1110. Those of skill in the art will appreciate that the functionality of data server 1110 (or web server 1106, computer 1104, laptop 1102) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

Using the techniques described herein, configurations of nanoparticles, microspheres made up of nanoparticles, bulk materials made up of such microspheres, and other arrays array of nanoparticles may be configured to yield particular desired structural color properties.

The following list of aspects reflects a variety of the embodiments explicitly contemplated by the present disclosure. Those of ordinary skill in the art will readily appreciate that the aspects below are neither limiting of the embodiments disclosed herein, nor exhaustive of all of the embodiments conceivable from the disclosure above, but are instead meant to be exemplary in nature.

1. A method comprising: providing, to a processor of a simulation system, one or more input properties, wherein each of the one or more input properties is indicative of a property of an array of nanoparticles; providing, to the processor, one or more input parameters for an optical simulation; performing, by the processor, the optical simulation by applying a stochastic model of the array of nanoparticles according to the input parameters; and determining, by the processor, and from the optical simulation, an output optical parameter indicative of structural color.

2. The method of aspect 1, wherein the one or more input properties comprise one or more of a structural property of the array of nanoparticles and an optical property of the array of nanoparticles.

3. The method of aspect 2, wherein the structural property of the array of nanoparticles comprises one or more of a nanoparticle size, a nanoparticle shape, a nanoparticle material, a nanoparticle porosity, a surface feature of a nanoparticle, a lattice constant of a plurality of nanoparticles, a concentration of nanoparticles in a medium, a void size of a nanoparticle, a property of a direct structure, a property of an inverse structure, a property of an ordered structure, a property of a disordered structure, a size of a microsphere of the array of nanoparticles, a shape of a microparticle composed of the array of nanoparticles, a nanoparticle polydispersity, a shell thickness, and a shell material.

4. The method of aspect 2, wherein the optical parameter of the array of nanoparticles comprises one or more of a real index of refraction, a complex index of refraction, an absorption value, a dispersion value, a birefringence, a polarization, a nonlinear coefficient.

5. The method of any of aspects 1 to 4, wherein the array of nanoparticles is a portion of a bulk material.

6. The method of any of aspects 1 to 5, wherein the one or more output optical parameters comprises one or more of a wavelength, range of wavelengths, reflection curve, transmission curve, absorption curve, a speckle amount, a scattering parameter, an angle dependence, and angle independence.

7. The method of any of aspects 1 to 6, wherein the stochastic model comprises a Monte Carlo model.

8. The method of any of aspects 1 to 7, wherein the stochastic model comprises a two-tiered stochastic model.

9. The method of any of aspects 1 to 8, wherein the one or more input properties comprises one or more medium parameters.

10. The method of aspect 9, wherein the one or more medium parameters comprises one or more of a material, a complex refractive index of the medium, a microsphere concentration, a microsphere mixture, an absorber amount, an absorber concentration, a thickness of the array of nanoparticles, or a degree of order of the array of nanoparticles

11. The method of any of aspects 1 to 10, further comprising producing at least one of a dye, a paint, or a coating comprising the array of nanoparticles.

12. A simulation system for determining structural color, the system comprising a processor configured to execute machine readable instructions that cause the processor to: receive one or more input properties, wherein each of the one or more input properties is indicative of a property of an array of nanoparticles; receive one or more input parameters for an optical simulation; perform the optical simulation by applying a stochastic model of the array of nanoparticles according to the input parameters; and determine from the optical simulation an output optical parameter indicative of structural color.

13. The system of aspect 12, wherein the one or more input properties comprise one or more of a structural property of the array of nanoparticles and an optical property of the array of nanoparticles.

14. The system of aspect 13, wherein the structural property of the array of nanoparticles comprises one or more of a nanoparticle size, a nanoparticle shape, a nanoparticle material, a nanoparticle porosity, a surface feature of a nanoparticle, a lattice constant of an array of nanoparticles, a concentration of nanoparticles in a medium, a void size of a nanoparticle, a property of a direct structure, a property of an inverse structure, a property of an ordered structure, a property of a disordered structure, a nanoparticle polydispersity, a shell thickness, and a shell material.

15. The system of aspect 13, wherein the optical parameter of the array of nanoparticles comprises one or more of a real index of refraction, a complex index of refraction, an absorption value, a dispersion value, a birefringence, a polarization, and a nonlinear coefficient.

16. The system of any of aspects 12 to 15, wherein the one or more output optical parameters comprises one or more of a wavelength, range of wavelengths, reflection curve, transmission curve, absorption curve, a speckle amount, a scattering parameter, an angle dependence, and angle independence.

17. The system of any of aspects 12 to 16, wherein the stochastic model comprises a Monte Carlo model.

18. The system of any of aspects 12 to 17, wherein the one or more input properties comprises one or more medium parameters.

19. The system of aspect 18, wherein the one or more medium parameters comprises one or more of a material, a complex refractive index of the medium, a microsphere concentration, a microsphere mixture, an absorber amount, an absorber concentration, a thickness of the array of nanoparticles, or a degree of order of the array of nanoparticles

20. The system of any of aspects 12 to 19, further comprising a manufacturing device configured to produce a dye, paint, or coating including the array of nanoparticles.

21. A method comprising: providing, to a processor, one or more target properties, wherein each of the one or more target properties is indicative of a desired optical property of an array of nanoparticles; providing, to the processor, one or more input parameters for an optical simulation; performing, by the processor, an evolutionary algorithm according to the input properties and input parameters, and wherein the evolutionary algorithm employs an optical simulation of the array of nanoparticles; and determining, by the processor, and from the evolutionary algorithm, an output design parameter indicative of one or more properties of the array of nanoparticles.

22. The method of aspect 21, wherein the one or more properties of the array of nanoparticles comprises one or more of a nanoparticle size, a nanoparticle shape, a nanoparticle material, a nanoparticle porosity, a surface feature of a nanoparticle, a lattice constant of an array of nanoparticles, a concentration of nanoparticles in a medium, a nanoparticle polydispersity, a shell thickness, and a shell material.

23. The method of either aspect 21 or aspect 22, wherein the one or more target properties indicative of a desired optical property comprises one or more of a wavelength, a range of wavelengths, a reflection curve, a transmission curve, an absorption curve, a speckle amount, a scattering parameter, a target transport length, a structural color, an angle dependence, and an angle independence.

24. The method of any of aspects 21 to 23, further comprising producing at least one of a dye, a paint, or a coating comprising the array of nanoparticles having the output structural design parameters.

25. The method of any of aspects 21 to 24, wherein the evolutionary algorithm comprises one of a maximum likelihood optimization, a differential evolution algorithm, a Bayesian optimization, genetic algorithm, a covariance matrix adaptation evolution strategy, a particle swarm optimization, and simulated annealing.

26. The method of any of aspects 21 to 25, wherein the one or more input parameters comprises a medium parameter including one or more of a type of a medium, a complex refractive index of the medium, a microsphere concentration, a microsphere mixture, an absorber amount, an absorber concentration, a property of the absorber, a thickness of the array of nanoparticles, array of nanoparticles, thickness of a bulk material made up of microspheres, or a degree of order of the array of nanoparticles.

27. The method of any of aspects 21 to 26, wherein the one or more input parameters comprises a manufacturing parameter that includes a limitation on at least one parameter of one or more of a include one or more properties of the array of nanoparticles, a structural property of the array of nanoparticles, an optical property of the array of nanoparticles, or a medium parameter.

28. The method of any of aspects 21 to 27, wherein the evolutionary algorithm further applies one or more of box constraints and soft constraints to one of the input properties or input parameters.

29. The method of any of aspects 21 to 28, wherein determining the output design parameter further comprises: stopping, by the processor, the evolutionary algorithm upon satisfying a stop condition; and storing, by the processor, the output design parameter in a non-transitory memory.

30. The method of aspect 29, wherein the stop condition comprises one of performing a predetermined number of iterations, elapsing of a predetermined amount of time, a predefined threshold of a rate of change of the objective function, a determination of stagnation of the objective function over a predefined number of iterations, and a threshold value of the objective function.

31. A optimization system comprising a processor configured to execute machine readable instructions that cause the processor to: receive one or more target properties, wherein each of the one or more target properties is indicative of a desired optical property of an array of nanoparticles; receive one or more input parameters for an optical simulation; perform an evolutionary algorithm according to the input properties and input parameters, and wherein the evolutionary algorithm employs an optical simulation of the array of nanoparticles; and determine an output design parameter from the evolutionary algorithm, the output design parameter being indicative of one or more properties of the array of nanoparticles.

32. The optimization system of aspect 31, wherein the one or more properties of the array of nanoparticles comprises one or more of a nanoparticle size, a nanoparticle shape, nanoparticle material, a nanoparticle porosity, a surface feature of a nanoparticle, a lattice constant of the array of nanoparticles, a concentration of nanoparticles in a medium, a nanoparticle polydispersity, a shell thickness, and a shell material.

33. The optimization system of either aspect 31 or aspect 32, wherein the one or more target properties indicative of a desired optical property comprises one or more of a wavelength, a range of wavelengths, a reflection curve, a transmission curve, an absorption curve, a speckle amount, a scattering parameter, a target transport length, a structural color, an angle dependence, and angle independence.

34. The optimization system of any of aspects 31 to 33, further comprising a manufacturing device configured to produce a dye, paint, or coating including the array of nanoparticles.

35. The optimization system of any of aspects 31 to 34, wherein the evolutionary algorithm comprises one of a maximum likelihood optimization, a differential evolution algorithm, a Bayesian optimization, a genetic algorithm, a covariance matrix adaptation evolution strategy, a particle swarm optimization, and simulated annealing.

36. The optimization system of any of aspects 31 to 35, wherein the one or more input parameters comprises a medium parameter including one or more of a type of a medium, a complex refractive index of the medium, a microsphere concentration, a microsphere mixture, an absorber amount, an absorber concentration, a property of the absorber, a thickness of the array of nanoparticles, array of nanoparticles, thickness of a bulk material made up of microspheres, or a degree of order of the array of nanoparticles.

37. The optimization system of any of aspects 31 to 36, wherein the one or more input parameters comprises a manufacturing parameter that includes a limitation on at least one property of the array of nanoparticles including a structural property of the array of nanoparticles, an optical property of the array of nanoparticles, or a medium parameter.

38. The optimization system of any of aspects 31 to 37, wherein the evolutionary algorithm further applies one or more of box constraints and soft constraints to one of the input properties or input parameters.

39. The optimization system of any of aspects 31 to 38, wherein to determine the output design parameter the machine readable instructions further cause the processor to: stop the evolutionary algorithm upon satisfying a stop condition; and store the output design parameter in a non-transitory memory.

40. The optimization system of aspect 39, wherein the stop condition comprises one of performing a predetermine number of iterations, elapsing of a predetermined amount of time, a predefined threshold of a rate of change of the objective function, a determination of stagnation of the objective function over a predefined number of iterations, and a threshold value of the objective function.

1. A method comprising:
providing, to a processor of a simulation system, one or more input properties, wherein each of the one or more input properties is indicative of a property of one or more arrays of nanoparticles, and wherein each of the arrays of nanoparticles is contained within one of a plurality of microspheres, and wherein the plurality of microspheres is contained within a bulk material;
providing, to the processor, one or more input parameters for an optical simulation;
performing, by the processor, the optical simulation by applying a stochastic model of the array of nanoparticles according to the input parameters, wherein the optical simulation accounts for properties of light as applied to the bulk material and microspheres thereof; and
determining, by the processor, and from the optical simulation, an output optical parameter indicative of structural color.

2. The method of claim 1, wherein the one or more input properties comprise one or more of a structural property of the one or more arrays of nanoparticles and an optical property of the one or more arrays of nanoparticles.

3. The method of claim 2, wherein the structural property of the one or more arrays of nanoparticles comprises one or more of a nanoparticle size, a nanoparticle shape, a nanoparticle material, a nanoparticle porosity, a surface feature of a nanoparticle, a lattice constant of a plurality of nanoparticles, a concentration of nanoparticles in a medium, a void size of a nanoparticle, a property of a direct structure, a property of an inverse structure, a property of an ordered structure, a property of a disordered structure, a size of a microsphere of the array of nanoparticles, a shape of a microparticle composed of the at least one array of nanoparticles, a nanoparticle polydispersity, a shell thickness, a shell material, a concentration of microspheres in the bulk material, and a thickness of the bulk material.

4. The method of claim 2, wherein the optical parameter of the one or more arrays of nanoparticles comprises one or more of a real index of refraction, a complex index of refraction, an absorption value, a dispersion value, a birefringence, a polarization, a nonlinear coefficient.

5. The method of claim 1, wherein the one or more output optical parameters comprises one or more of a wavelength, range of wavelengths, reflection curve, transmission curve, absorption curve, a speckle amount, a scattering parameter, an angle dependence, and angle independence.

6. The method of claim 1, wherein the stochastic model comprises a Monte Carlo model.

7. The method of claim 1, wherein the stochastic model comprises a two-tiered stochastic model.

8. The method of claim 1, wherein the one or more input properties comprises one or more medium parameters.

9. The method of claim 7, wherein the one or more medium parameters comprises one or more of a material, a complex refractive index of the medium, a microsphere concentration, a microsphere mixture, an absorber amount, an absorber concentration, a thickness of the array of nanoparticles, or a degree of order of the array of nanoparticles

10. The method of claim 1, further comprising producing the bulk material, wherein the bulk material includes at least one of a dye, a paint, or a coating comprising the one or more arrays of nanoparticles.

11. A simulation system for determining structural color, the system comprising a processor configured to execute machine readable instructions that cause the processor to:
receive one or more input properties, wherein each of the one or more input properties is indicative of a property of an array of nanoparticles, the array of nanoparticles being part of a bulk material, the bulk material including at least one microsphere containing the array of nanoparticles;
receive one or more input parameters for an optical simulation;
perform the optical simulation by applying a stochastic model of the array of nanoparticles according to the input parameters, wherein the optical simulation accounts for properties of light as applied to the bulk material; and
determine from the optical simulation an output optical parameter indicative of structural color.

12. The system of claim 11, wherein the one or more input properties comprise one or more of a structural property of the array of nanoparticles and an optical property of the array of nanoparticles.

13. The system of claim 12, wherein the structural property of the array of nanoparticles comprises one or more of a nanoparticle size, a nanoparticle shape, a nanoparticle material, a nanoparticle porosity, a surface feature of a nanoparticle, a lattice constant of an array of nanoparticles, a concentration of nanoparticles in a medium, a void size of a nanoparticle, a property of a direct structure, a property of an inverse structure, a property of an ordered structure, a property of a disordered structure, a nanoparticle polydispersity, a shell thickness, a shell material, a concentration of microspheres in the bulk material, and a thickness of the bulk material.

14. The system of claim 12, wherein the optical parameter of the array of nanoparticles comprises one or more of a real index of refraction, a complex index of refraction, an absorption value, a dispersion value, a birefringence, a polarization, and a nonlinear coefficient.

15. The system of claim 11, wherein the one or more output optical parameters comprises one or more of a wavelength, range of wavelengths, reflection curve, transmission curve, absorption curve, a speckle amount, a scattering parameter, an angle dependence, and angle independence.

16. The system of claim 11, wherein the stochastic model comprises a Monte Carlo model.

17. The system of claim 11, wherein the one or more input properties comprises one or more medium parameters.

18. The system of claim 17, wherein the one or more medium parameters comprises one or more of a material, a complex refractive index of the medium, a microsphere concentration, a microsphere mixture, an absorber amount, an absorber concentration, a thickness of the array of nanoparticles, or a degree of order of the array of nanoparticles

19. The system of claim 11, further comprising a manufacturing device configured to produce the bulk material, wherein the bulk material includes at least one of a dye, paint, or coating including the array of nanoparticles.

20. A method comprising:
providing, to a processor, one or more target properties, wherein each of the one or more target properties is indicative of a desired optical property of an array of nanoparticles, the array of nanoparticles being part of a bulk material, wherein the bulk material includes at least one microparticle containing the array of nanoparticles;
providing, to the processor, one or more input parameters for an optical simulation;
performing, by the processor, an evolutionary algorithm according to the input properties and input parameters, wherein the evolutionary algorithm employs an optical simulation of the array of nanoparticles, and wherein the optical simulation accounts for properties of light as applied to the bulk material; and
determining, by the processor, and from the evolutionary algorithm, an output design parameter indicative of one or more properties of the array of nanoparticles.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)
